(19) United States
(12) Patent Application Publication
(10) Pub. No.: US 2005/0198838 A1
(43) Pub. Date: Sep. 15, 2005

(54) Manual can opener with crank handle

(76) Inventor: Marta Brucart Bonich, Sabadell (ES)

Correspondence Address: Striker, Striker & Stenby, 103 East Neck Road, Huntington, NY, 11743, US

(21) Appl. No.: 10/495,934

(22) PCT Filed: Nov. 19, 2002
(86) PCT No.: PCT/ES02/00540

§ 371 Date: Apr. 22, 2005

(30) Foreign Application Priority Data
Nov. 19, 2001 (ES) P 0102555

(51) Int. Cl. B67B 7/46

(52) U.S. Cl. 30/416; 30/419

(57) ABSTRACT

The invention relates to an improved can opener which is designed to open a metal container by making a continuous, peripheral cut in the corresponding upper cover of said container. The inventive device is of the type that comprises a pair of interarticulated arms which define a clamp therebetween. According to the invention, one arm is tilted in relation to the other in order to close said clamp and mount the cutting edge on the cover of the container. The aforementioned cover is then cut by rotating a toothed wheel which in turn moves the can opener along the perimeter of the container, the upper edge of the container being disposed between said toothed wheel and a lateral flange of the main arm. The toothed wheel is rotated using a rotation-mounted manual actuation lever or crank handle. Moreover, a ratchet is provided which enables the toothed wheel to rotate continuously and the can opener to move along the perimeter of the container by subjecting the crank handle or lever to an alternating tilt movement.

### OBJECT OF THE INVENTION

The present invention refers to a manual can opener with crank handle, the evident purpose of which is to serve as means for carrying out the opening of metal containers, such as cans and tinplate cans, containing foodstuffs.

The object of the invention is to provide the market and general public with a can opener having a series of novelty features on the basis of which new features are obtained, such as less effort in carrying out the manual opening of the container, a longer duration of the useful life of the can opener itself, and even a greater efficacy in the function thereof.

### BACKGROUND OF THE INVENTION

Several types of openers for carrying out the opening of classic metal containers containing foodstuffs are known, containers which are usually the profusely commercialized cans and/or tinplate cans.

The opening is carried out in some cases by manual pulling of a ring or tab, on the basis of which pulling a tearing through a perforated line on a corresponding closure cover occurs, the latter materializing the upper base of the container. In other cases, the opening is carried out by means of cutting said cover in order to separate it from the container, or at least cutting off one part of said cover to allow the exit of the contents.

Among the can openers by means of which the opening by cutting is carried out, one type is known that is based on a kind of clamp formed by means of two arms manually actuated in order to be able to carry out the opening and/or closure of the clamp itself, such that in the closed position of the latter, a suitably arranged cutting edge is applied on the cover of the container, producing the cutting thereof. Said can opener is also equipped with a laterally arranged toothed ring, constituting the means for moving the can opener along the container periphery, to produce in this movement a perimetral cutting of said cover and with it, the intended opening.

The peripheral edge of the cover is arranged between a lower stop or flange provided on one of the arms of the clamp and the toothed ring itself, for the purpose of establishing the guiding means in the movement and of allowing for the continuous cut to occur and without slips of the can opener occurring.

The operation for carrying out the cutting is performed by means of rotating the bracket provided on the side opposite to the toothed ring for moving the can opener.

One of the drawbacks which said type of can openers has is the remarkable manual effort required to actuate the bracket, due to the reduced dimensions thereof, which also give rise to the fact that the actuation of such a bracket is not comfortable.

Another drawback is focused on the lack of stability in the positioning and moving of the can opener along the container when the corresponding clamp is closed, since with time looseness develops between the two articulated arms of said clamp, allowing the can opener to uncouple from the container through the supporting stop or flange and to slip over the lower edge of the classical rim of the container.

### DESCRIPTION OF THE INVENTION

The proposed can opener, being of the second type of those referred to in the previous section, i.e. of those carrying out the opening by means of continuous cutting or sectioning of the cover, has a series of particularities and novelty features by means of which the previously mentioned drawbacks are solved. That is to say, the can opener of the invention is of the type of those constituted from a kind of clamp with two arms closing the cutting edge on the cover of the container intended to be opened by means of cutting or sectioning of said cover.

One of the novelty features of the can opener of the invention consists of incorporating a manual actuation crank handle to replace the classic bracket, said crank handle being of remarkable length in order to provide a long lever arm allowing to be actuated by rotation with a minimum effort.

Another novelty feature of the can opener consists of the fact that one of the two arms of the clamp, specifically the one tilting with respect to the other arm, has a grooved configuration which, in combination with a projection of the other arm, considering the latter as the main one, provides a tongue-and-groove coupling between both elements in the operative position of the can opener, which makes the hinge pin of said arms neither support nor be subjected to stresses which could cause a displacement thereof with regard to the hinge pin itself.

Another novelty feature of the can opener consists of a very ergonomic configuration of the main arm allowing for a more comfortable handling of the can opener.

Another novelty feature of the can opener consists of the incorporation of a ratchet allowing for carrying out the continuous cut of the cover without needing to carry out the complete rotation of the crank handle, it being enough to carry out consecutive tilt movements in both directions of the crank handle itself, which can be achieved by means of said ratchet.

This solution allows for carrying out the opening of any container supported on a surface, such as the kitchen countertop, tabletop, etc., without the necessity that the height of the container is greater than or equal to the length of the crank handle.

Optionally, said crank handle can be articulated through a point of the intermediate length thereof, defining two parts, one of which could in certain circumstances tilt outwards and be situated such that it forms an angulation with regard to the other part, thereby achieving the reduction of the length of said crank handle, which would facilitate the actuation thereof.

### DESCRIPTION OF THE DRAWINGS

To complement the description being made and for the purpose of helping to better understand the features of the invention according to a preferred practical embodiment example thereof, a set of drawings is attached as an integral part of said description, wherein the following has been shown in an illustrative and non-limiting manner:

FIG. 1 shows a side perspective view of the can opener of the invention, in an inoperable position, i.e. with the two arms in an open position, the length of the crank handle for manual actuation being seen.

FIG. 2 also shows a perspective view, in this case of the other side of the same can opener, in operative position, i.e. with the two clamp arms closed.

FIG. 3 shows a side perspective view of a can opener with two arms in the open position, provided with a manual actuation lever.

FIG. 4 also shows a perspective view of the previous can opener in which the side fitting notch is seen.

FIG. 5 shows a perspective view of a can opener in which a lower oscillating arm is seen.

FIGS. 6 and 7 show details of the ratchets.

FIG. 8 shows a detail of the pulling of the can opener, in which the shaft on the ends of which there is a toothed wheel and the crank handle, respectively, is seen.

FIG. 9 shows a detail of the tilting the crank handle of the can opener.

FIGS. 10 and 11 show two gear systems for the pulling.

### PREFERRED EMBODIMENT OF THE INVENTION

In view of the described figures, it can be observed how the can opener of the invention comprises two arms (1-2) connected to one another through a hinge pin (3). The arm (1) is considered as the main arm, whereas the arm (2) is considered as the tilted one, since the latter is the one which tilts with respect to the arm (1) through said shaft (3).

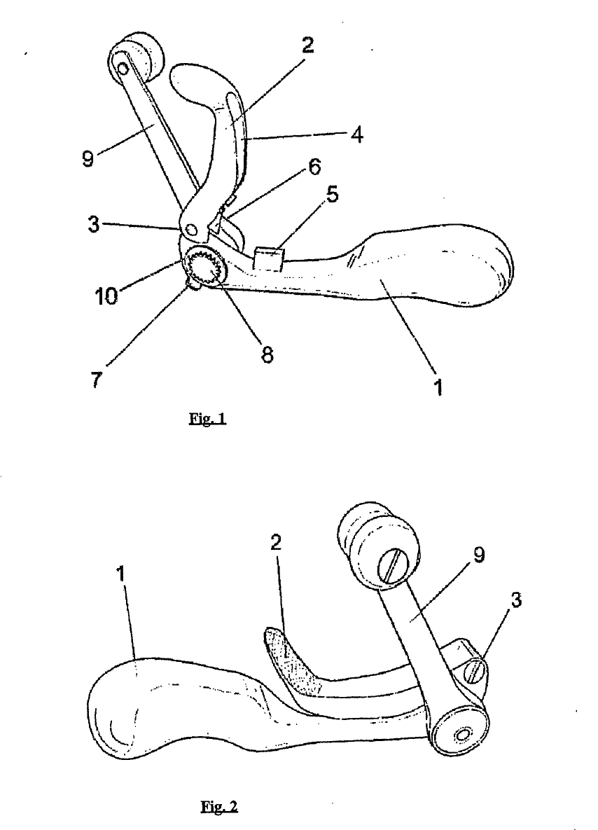

A clamp is defined between both arms (1-2) which clamp, in an inoperative position shown in FIG. 1, remains open, whereas in the operative position shown in FIG. 2, both arms (1-2) are superimposed. The tilting arm (2), of remarkably longer length than the main arm (1), has a grooved configuration (4) in the portion facing said main arm (1), the latter having a projection (5) defining a tongue-and-groove coupling between both parts or elements in the closed or operative position, making it so that the pivot shaft (3) is not subjected to side stresses.

The tilting arm (2) bears the corresponding cutting edge (6) which is applied on the container when the closure of the clamp formed by both arms (1) and (2) occurs. A flange or stop (7), as well as a toothed wheel (8), have been provided on one side of the arm, the toothed wheel constituting the means for driving the can opener along the perimeter of the container when the opening thereof is carried out, since the edge of such container will be positioned between said flange (7) and the toothed wheel (8). Between the toothed wheel (8) and the main arm (1) there is a steel bushing washer (10) notched with the flange or stop (7) to prevent rubbing of the can with the resulting wear of the material.

The can opener includes, as one of the most fundamental novelty features thereof, a crank handle (9) mounted on the shaft of the toothed wheel (8), so that the rotation of the crank handle (9) will lead to the movement the can opener along the perimeter of the container, and therefore the cutting or sectioning of the cover by means of the cutting edge (6), all this on the basis that the toothed wheel (8) rotates while supported on the container, this rotation moving the can opener assembly along the container itself, and therefore cutting the corresponding cover by means of the cutting edge (6).

In order to prevent the crank handle (9) from having to perform the complete rotation, a ratchet (11) has been provided which allows for the driving or continuous rotation of the toothed wheel (8), without needing the complete rotation of said crank handle (9) to occur, since it will be sufficient to subject the latter to an alternative tilting movement.

On the other hand, the fact that both the main arm (1) and the tilting arm (2) have an ergonomic configuration is worth emphasizing, all this so that the special and ergonomic configuration of the main arm (1), acting as a handle, provides an easy and comfortable handling for the user.

For the purpose of helping the rotation of the crank handle, and of separating the gripping actuation knob (21) of the crank handle (20) of the main body, a drive shaft (13) has been provided, as shown in FIG. 8, in which it is seen that one end still has the toothed wheel (8), and a connecting rod (14) can be seen on the other end, on which rod the crank handle (20) tilts by means of the turning axis (15).

This crank handle (20), tilts on the connecting rod (14) by means of an axis (15) substantially spaced from the shaft (13), so that it allows being spaced from the main body (1), as can be seen in FIG. 8, thus facilitating the operation in the use of the can opener, the hands not colliding, since while one supports the main body the other one rotates the crank handle.

It is also worth emphasizing that the lever (20) and the toothed wheel (8) rotate on different shafts, connected to one another by means of respective gears, as shown in FIGS. 10 and 11, to change the rotation ratio of both.

It is also worth emphasizing that the gripping knob (21) of the crank handle (20) can be of a magnetic configuration, so that once the operation for which the latter is intended in the can opener is carried out, it can adhere to the cut cover for the raising and separation thereof from the can in question.

This magnetic gripping handle can likewise adhere to the main body in its bending position.

The crank handle (20) can have a retaining element (16) such as a groove or a ball with regard to the connecting rod (14), both in a working situation and at rest.

It is also worth mentioning the fact that the crank handle (9) can optionally be defined by two interarticulated parts, corresponding to an intermediate point of the length of such a lever (9), which would enable the end part to be able to be arranged such that it forms an angulation with the part linked to the body of the can opener, and thus reduce the length of such a lever (9) to facilitate the manipulation or actuation thereof.

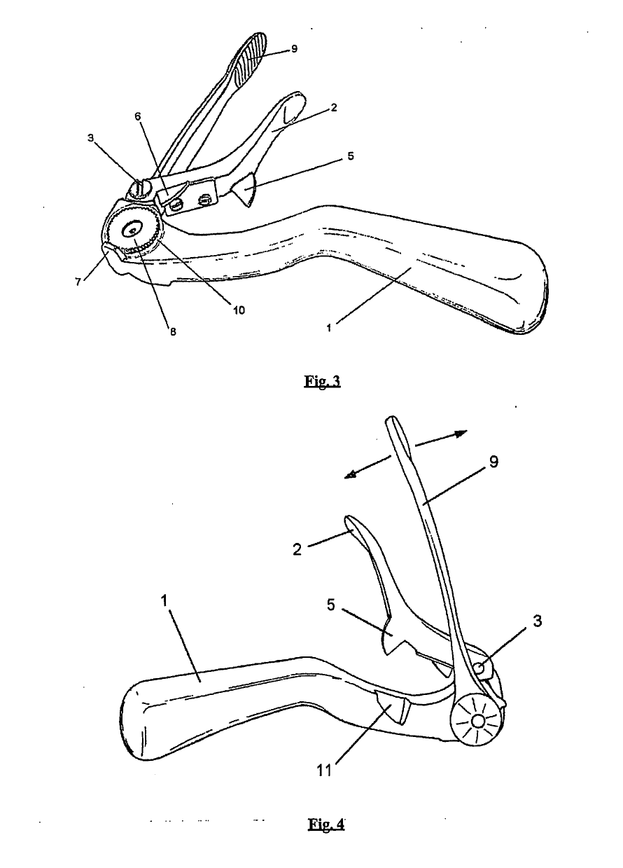

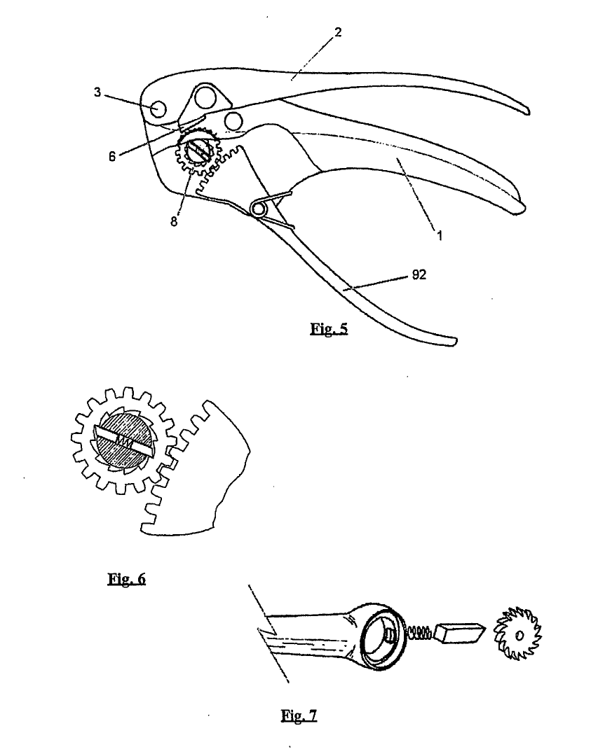

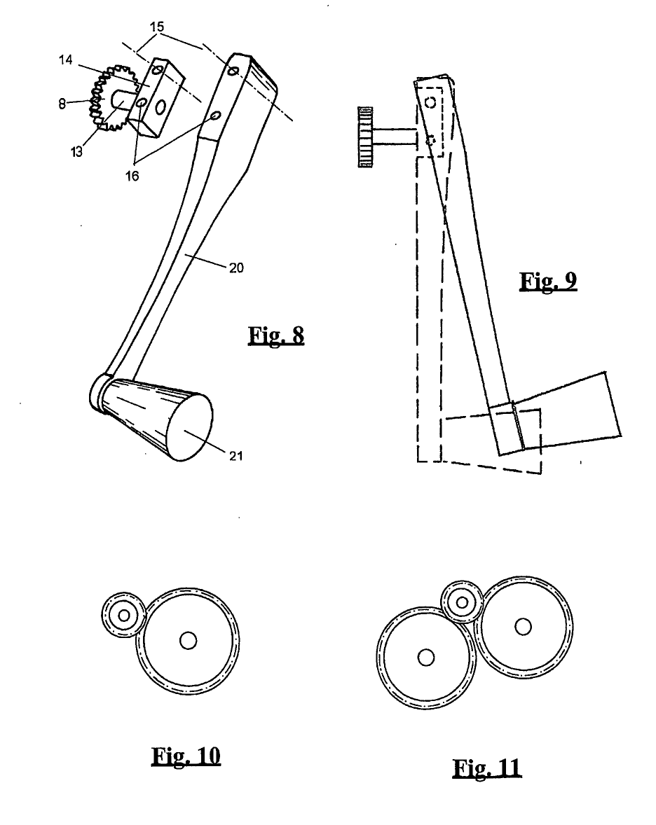

The improved can opener, as seen in FIGS. 3 and 4, has also provided for the housing of the projection (5) on the side opposite to the toothed wheel (8) and cutting edge (6) assembly, in the cavity or groove (12), achieving the same effect as that described in FIGS. 1 and 2.

The crank handle or lever (9) can be symmetrically placed on the same plane as the main body of the assembly as seen in FIG. 5, such that the can opener can be actuated with only one hand.

According to said features, the application and operation of the can opener of the invention is as follows:

The corresponding edge of the container is introduced between the flange (7) and the lower area of the toothed wheel (8), so that once this position is achieved, the arm (2) is then tilted downwards until the cutting edge (6) provided on the latter initiates the cutting of the cover corresponding to the container. Then, the crank handle (9) or lever (91) and (92) are actuated, the alternative tilting movement of which, allowed by the ratchet (10), leads to a continuous rotation of the toothed wheel (8) which will act as a driving element and, therefore, as an element for moving the can opener along the entire perimeter of the container.

Having sufficiently described the nature of the invention, as well as some preferred embodiment examples, it is hereby stated for suitable purposes that the materials, shape, size and arrangement of the described elements may be modified, as long as this does not assume a change of the essential features of the invention which are claimed below.

1. A manual can opener with crank handle, which is designed to open a metal container by making a continuous and perimetral cut in the corresponding upper cover of said container and is of the type that comprises a pair of interarticulated arms which define a clamp therebetween, one arm tilted in relation to the other in order to close said clamp and mount the cutting edge on the cover of the container which is then cut by rotating a toothed wheel which in turn moves the can opener along the perimeter of the container, the upper edge of the container being disposed between said toothed wheel and a lateral flange of the main arm, characterized in that the rotation of the toothed wheel is carried out by means of a rotation-mounted manual actuation crank handle or lever; a ratchet having been provided which enables the toothed wheel to rotate continuously and the can opener to move along the perimeter of the container by subjecting the crank handle or lever to an alternating tilt movement.

2. A manual can opener with crank handle according to claim 1, characterized in that the crank handle tilts over a connecting rod which is placed at the other end of the drive shaft.

3. A manual can opener with crank handle according to, characterized in that the drive shaft is different from the control shaft of the crank handle, both shafts being connected by means of gears.

4. A manual can opener with crank handle according to, characterized in that the manual actuation crank handle or lever is located on the side of the main body.

5. A manual can opener with crank handle according to claim 1, characterized in that the manual actuation lever is symmetrically located on the same plane as the main body.

6. A manual can opener with crank handle, according to claim 1, characterized in that the titling arm is provided with a projection in its portion facing the main arm, which projection, in combination with a notch arranged for that purpose on the main arm itself, determine a tongue-and-groove coupling of both elements, in the operative closed position between both arms.

7. A manual can opener with crank handle according to, characterized in that between the toothed driving wheel and the main body, there is a washer of a diameter that is noticeably greater than that of said wheel.

8. A manual can opener with crank handle according to, characterized in that both the tilting arm and the main arm have an ergonomic configuration for their suitable adaptation to the hand of the user, facilitating the manipulation of the can opener itself during its use.

9. A manual can opener with crank handle according to claim 2, characterized in that said connecting rod has a retaining device for retaining the crank handle.

10. A manual can opener with crank handle according to, characterized in that the grip of the crank handle is magnetic.
